(19) United States
(12) Patent Application Publication
(10) Pub. No.: US 2026/0246552 A1
(43) Pub. Date: Aug. 20, 2026

(54) METHOD AND NETWORK DEVICE FOR PTP CLOCK SYNCHRONIZATION

(71) Applicant: Telefonaktiebolaget LM Ericsson (publ), Stockholm (SE)

(72) Inventors: Guoliang Gao, Beijing (CN); Liya Shao, Beijing (CN); Liang Shan, Beijing (CN)

(21) Appl. No.: 18/992,603

(22) PCT Filed: Jul. 12, 2022
(86) PCT No.: PCT/CN2022/105207

§ 371 Date: Jan. 9, 2025

(51) Int. Cl. H04J 3/06

(52) U.S. Cl. CPC H04J 3/0667

(57) ABSTRACT

A method and a network device are disclosed for precision time protocol (PTP) clock synchronization. According to an embodiment, the network device determines, for a plurality of candidate PTP clock sources, noise metrics reflecting variation degrees of propagation delays on paths between the plurality of candidate PTP clock sources and the network device. The network device determines, from the plurality of candidate PTP clock sources, a target PTP clock source for clock synchronization, based on at least part of the noise metrics.

### TECHNICAL FIELD

Embodiments of the disclosure generally relate to communication, and, more particularly, to a method and a network device for precision time protocol (PTP) clock synchronization.

### BACKGROUND

This section introduces aspects that may facilitate better understanding of the present disclosure. Accordingly, the statements of this section are to be read in this light and are not to be understood as admissions about what is in the prior art or what is not in the prior art.

Synchronization is currently a hotspot technology. Especially in mobile backhaul network, the distribution of synchronization is a vital feature. The mobile backhaul network won't be able to work well without a proper synchronization. New mobile communication technologies require synchronized phase and precise time of day (ToD) in addition to synchronized frequency. These technologies are e.g. long term evolution-time division duplex (LTE-TDD), mobile world interoperability for microwave access (WiMAX)/TDD, time division-synchronous code division multiple access (TD-SCDMA), and femtocell. The general requirement on the air interface is a frequency accuracy of 50 part per billion (ppb) and a phase/time accuracy of the order of 1 usec (e.g. for CDMA2000, it is about ±3 usec; for LTE-TDD large cell, it is about ±5 usec; for LTE-TDD small cell, it is about ±1.5 usec).

The institute of electrical and electronics engineers (IEEE) 1588 version 2 (V2), also known as precision time protocol (PTP), is an industry-standard protocol that enables the precise transfer of frequency and time to synchronize clocks over packet-based Ethernet networks. In order to serve telecom environment, several specific profiles from the international telecommunications unit-telecommunication (ITU-T) was defined by using IEEE1588v2 as the base. In these profiles, for timing/phase sync support, the profiles are: 1) ITU-T G.8275.1 (ITU-T G.8275.1/Y.1369.1), “Precision time protocol telecom profile for phase/time synchronization with full timing support from the network”; and 2) ITU-T G.8275.2/Y.1369.2, “Precision time protocol telecom profile for phase/time synchronization with partial timing support from the network”. For frequency synchronization, the profile is ITU-T G.8265.1/Y.1365.1, “Precision time protocol telecom profile for frequency synchronization”.

PTP/1588 uses best master clock algorithm (BMCA) to select the best grandmaster (GM) clock to synchronize the local clock. Though respective telecom profiles and IEEE1588v2 use their own BMCA algorithms with slight difference, they are all derived from the basic body from IEEE1588v2-2008. The detailed information of each tie-break can be obtained from: 1) Section 9.3 of IEEE1588v2-2008, FIG. 27—Data set comparison algorithm part 1, and FIG. 28—Data set comparison algorithm part 2; 2) Section 6.7 of ITU-T G.8275.2, FIG. 3—Data set comparison algorithm, part 1, for Alternate BMCA, and FIG. 4—Data set comparison algorithm, part 2, for Alternate BMCA; 3) Section 6.3 of ITU-T G.8275.1, FIG. 2—Data set comparison algorithm, part 1, for Alternate BMCA, and FIG. 3—Data set comparison algorithm, part 2, for Alternate BMCA; and 4) Section 6.7 of ITU-T G.8265.1, alternative BMCA telecom slave model and master selection process.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for PTP clock synchronization. In particular, one of the problems to be solved by the disclosure is that the existing solution for PTP clock source selection could not select the best clock source due to lack of consideration of on-path noise.

According to a first aspect of the disclosure, there is provided a method performed by a network device. The method may comprise determining, for a plurality of candidate PTP clock sources, noise metrics reflecting variation degrees of propagation delays on paths between the plurality of candidate PTP clock sources and the network device. The method may further comprise determining, from the plurality of candidate PTP clock sources, a target PTP clock source for clock synchronization, based on at least part of the noise metrics.

In this way, it is possible to select the best clock source thereby improving the clock accuracy of the network.

In an embodiment of the disclosure, determining the target PTP clock source may comprise determining a better one from a first candidate PTP clock source and a second candidate PTP clock source, based on the noise metrics of the first and second candidate PTP clock sources.

In an embodiment of the disclosure, determining the better one from the first and second candidate PTP clock sources may comprise determining a difference between the noise metric of the first candidate PTP clock source and the noise metric of the second candidate PTP clock source. Determining the better one from the first and second candidate PTP clock sources may further comprise determining the better one from the first and second candidate PTP clock sources, based on a comparison between the difference and a predetermined positive threshold.

In an embodiment of the disclosure, the first candidate PTP clock source may be determined as the better one, when the difference is smaller than an opposite number of the predetermined positive threshold. Or the second candidate PTP clock source may be determined as the better one, when the difference is greater than the predetermined positive threshold. Or the first and second candidate PTP clock sources may be determined to be equally good, when the difference is greater than or equal to the opposite number of the predetermined positive threshold and smaller than or equal to the predetermined positive threshold.

In an embodiment of the disclosure, the target PTP clock source may be determined based further on capability parameters or status parameters of the plurality of candidate PTP clock sources.

In an embodiment of the disclosure, when a better one of a first candidate PTP clock source and a second candidate PTP clock source cannot be determined based on the capability parameters or the status parameters of the first and second candidate PTP clock sources, the better one may be determined based on the noise metrics of the first and second candidate PTP clock sources.

In an embodiment of the disclosure, the capability parameter of a candidate PTP clock source may comprise at least one of: a first parameter indicating international atomic time (TAI) traceability of the candidate PTP clock source; a second parameter indicating a static accuracy of the candidate PTP clock source; and a third parameter indicating a dynamic accuracy of the candidate PTP clock source.

In an embodiment of the disclosure, the status parameter of a candidate PTP clock source may comprise a fourth parameter indicating whether there is a failure of PTP packet timing signal received by the network device.

In an embodiment of the disclosure, the noise metric for a candidate PTP clock source may comprise a variance of the propagation delays on the path between the candidate PTP clock source and the network device within a predetermined time period.

In an embodiment of the disclosure, determining the noise metric for a candidate PTP clock source may comprise determining a set of propagation delays on the path between the candidate PTP clock source and the network device, based on timestamps related to PTP messages communicated between the candidate PTP clock source and the network device within the predetermined time period. Determining the noise metric for a candidate PTP clock source may further comprise determining, as the noise metric for the candidate PTP clock source, a variance of at least part of the set of propagation delays.

In an embodiment of the disclosure, the at least part of the set of propagation delays may be a predetermined number of propagation delays which are the smallest among the set of propagation delays.

In an embodiment of the disclosure, the variance may be based on one of: Allan deviation (ADEV); modified Allan deviation (MDEV); time deviation (TDEV); time interval error (TIE); and maximum TIE (MTIE).

In an embodiment of the disclosure, the network device may be configured to act as one of: a boundary clock (BC); and an ordinary clock (OC).

According to a second aspect of the disclosure, there is provided a network device. The network device may comprise at least one processor and at least one memory. The at least one memory may contain instructions executable by the at least one processor, whereby the network device may be operative to determine, for a plurality of candidate PTP clock sources, noise metrics reflecting variation degrees of propagation delays on paths between the plurality of candidate PTP clock sources and the network device. The network device may be further operative to determine, from the plurality of candidate PTP clock sources, a target PTP clock source for clock synchronization, based on at least part of the noise metrics.

In this way, it is possible to select the best clock source thereby improving the clock accuracy of the network.

In an embodiment of the disclosure, the network device may be operative to determine the target PTP clock source by determining a better one from a first candidate PTP clock source and a second candidate PTP clock source, based on the noise metrics of the first and second candidate PTP clock sources.

In an embodiment of the disclosure, the network device may be operative to determine the better one from the first and second candidate PTP clock sources by determining a difference between the noise metric of the first candidate PTP clock source and the noise metric of the second candidate PTP clock source. The network device may be operative to determine the better one from the first and second candidate PTP clock sources by determining the better one from the first and second candidate PTP clock sources, based on a comparison between the difference and a predetermined positive threshold.

In an embodiment of the disclosure, the first candidate PTP clock source may be determined as the better one, when the difference is smaller than an opposite number of the predetermined positive threshold. Or the second candidate PTP clock source may be determined as the better one, when the difference is greater than the predetermined positive threshold. Or the first and second candidate PTP clock sources may be determined to be equally good, when the difference is greater than or equal to the opposite number of the predetermined positive threshold and smaller than or equal to the predetermined positive threshold.

In an embodiment of the disclosure, the network device may be operative to determine the target PTP clock source based further on capability parameters or status parameters of the plurality of candidate PTP clock sources.

In an embodiment of the disclosure, when a better one of a first candidate PTP clock source and a second candidate PTP clock source cannot be determined based on the capability parameters or the status parameters of the first and second candidate PTP clock sources, the better one may be determined based on the noise metrics of the first and second candidate PTP clock sources.

In an embodiment of the disclosure, the capability parameter of a candidate PTP clock source may comprise at least one of: a first parameter indicating TAI traceability of the candidate PTP clock source; a second parameter indicating a static accuracy of the candidate PTP clock source; and a third parameter indicating a dynamic accuracy of the candidate PTP clock source.

In an embodiment of the disclosure, the status parameter of a candidate PTP clock source may comprise a fourth parameter indicating whether there is a failure of PTP packet timing signal received by the network device.

In an embodiment of the disclosure, the noise metric for a candidate PTP clock source may comprise a variance of the propagation delays on the path between the candidate PTP clock source and the network device within a predetermined time period.

In an embodiment of the disclosure, the network device may be operative to determine the noise metric for a candidate PTP clock source by determining a set of propagation delays on the path between the candidate PTP clock source and the network device, based on timestamps related to PTP messages communicated between the candidate PTP clock source and the network device within the predetermined time period. The network device may be operative to determine the noise metric for a candidate PTP clock source by determining, as the noise metric for the candidate PTP clock source, a variance of at least part of the set of propagation delays.

In an embodiment of the disclosure, the at least part of the set of propagation delays may be a predetermined number of propagation delays which are the smallest among the set of propagation delays.

In an embodiment of the disclosure, the variance may be based on one of: ADEV; MDEV; TDEV; TIE; and MTIE.

In an embodiment of the disclosure, the network device may be configured to act as one of: a BC; and an OC.

According to a third aspect of the disclosure, there is provided a computer program product. The computer program product may contain instructions which when executed by at least one processor, cause the at least one processor to perform the method according to the above first aspect.

According to a fourth aspect of the disclosure, there is provided a computer readable storage medium. The computer readable storage medium may store thereon instructions which when executed by at least one processor, cause the at least one processor to perform the method according to the above first aspect.

According to a fifth aspect of the disclosure, there is provided a network device. The network device may comprise a first determination module for determining, for a plurality of candidate PTP clock sources, noise metrics reflecting variation degrees of propagation delays on paths between the plurality of candidate PTP clock sources and the network device. The network device may further comprise a second determination module for determining, from the plurality of candidate PTP clock sources, a target PTP clock source for clock synchronization, based on at least part of the noise metrics.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating a scenario of PTP clock synchronization;

FIG. 2 is a diagram illustrating another scenario of PTP clock synchronization;

FIGS. 3A-3B are diagrams illustrating packet delay variations experienced by different PTP streams;

FIG. 4 is a flowchart illustrating the existing BMCA algorithm;

FIG. 5 is a flowchart illustrating a method performed by a network device according to an embodiment of the disclosure;

FIG. 6 is a flowchart for explaining the method of FIG. 5;

FIG. 7 is a flowchart for explaining the method of FIG. 5;

FIG. 8 is a flowchart for explaining the method of FIG. 5;

FIG. 9 is a block diagram showing an apparatus suitable for use in practicing some embodiments of the disclosure;

FIG. 10 is a block diagram showing a network device according to an embodiment of the disclosure;

FIG. 11 is a flowchart illustrating an improved BMCA algorithm according to an embodiment of the disclosure;

FIG. 12 is a flowchart for explaining the algorithm of FIG. 11;

FIG. 13 is a diagram illustrating a network device according to an embodiment of the disclosure;

FIG. 14 is a diagram illustrating the existing mechanism for PTP clock synchronization; and

FIG. 15 is a diagram illustrating the improved mechanism for PTP clock synchronization according to an embodiment of the disclosure.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

Network packet delay variation (PDV) is the most critical factor to impact the accuracy of the recovered clock. However, the current BMCA algorithm does not consider this factor when performing clock selection, which leads to unsuitable behavior in some cases especially when there is significant variable PDV between the master and slave clock (e.g. G.8275.2 scenarios for partial timing support). To illustrate more details of the problem existing, two typical deployment scenarios with the issues will be given by taking ITU-T G.8275.2 profile as an example. Note that other profiles have the similar situation though it might not be so critical as G.8275.2.

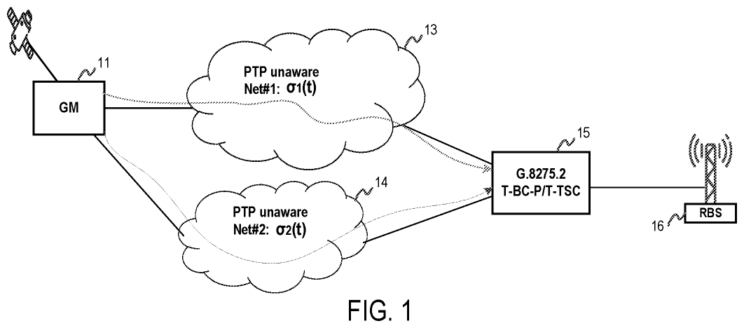

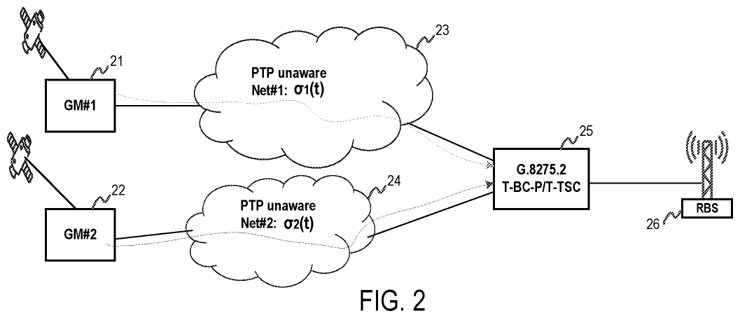

FIG. 1 illustrates a deployment example for path protection, in which the downstream G.8275.2 partial-support telecom boundary clock (T-BC-P)/telecom time slave clock (T-TSC) 15 monitors the same grandmaster (GM) clock 11 via different paths (e.g. PTP unaware sub-nets 13 and 14) and selects one as the sync source via alternative BMCA algorithm so that the radio base station (RBS) 16 can be synchronized with the G.8275.2 T-BC-P/T-TSC 15. FIG. 2 illustrates another example of clock protection scenario, in which the downstream G.8275.2 T-BC-P/T-TSC 25 monitors two different GM clocks 21 and 22 over different PTP-unaware sub-nets 23 and 24, and selects one best clock as its sync source.

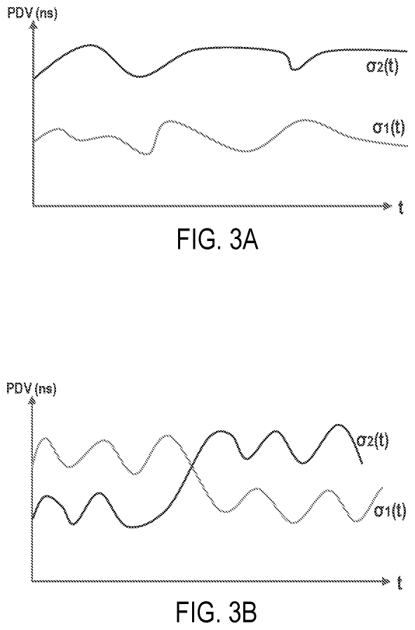

To better understand the path difference of the PDV, FIG. 3A and FIG. 3B illustrate the PDV situations of different paths, where σ1(t) is used to represent the PDV of the path 13 or 23, and σ2(t) is used to represent the PDV of the path 14 or 24. FIG. 3A reflects the case that σ1(t)<σ2(t). FIG. 3B reflects the case that σ1(t)>σ2(t) at the beginning, while σ1(t)<σ2(t) after some time, which could be caused because the network traffic model changes.

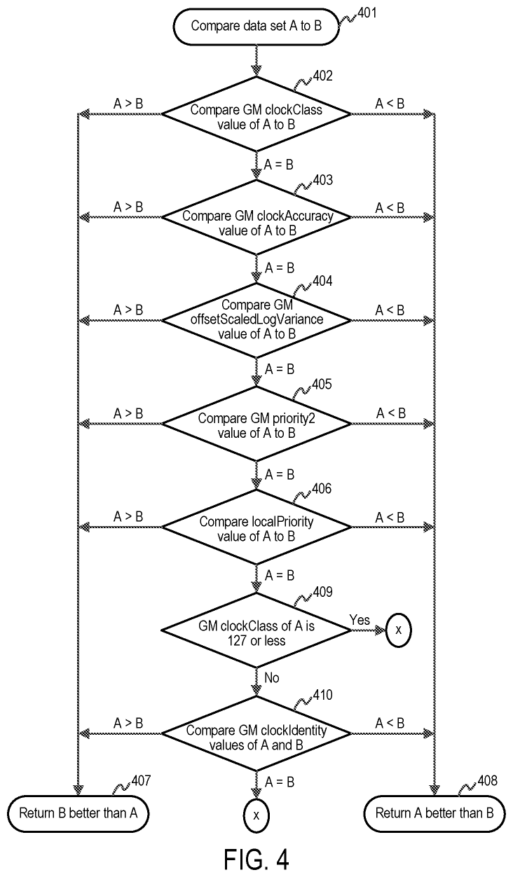

FIG. 4 is FIG. 3 of G.8275.2/Y.1369.2, Amendment 3 (February 2022), which illustrates data set comparison algorithm, part 1, for alternative BMCA. The algorithm selects the reference with the highest quality level that is not experiencing the signal fail (SF) conditions such as PTSF-lossSync or PTSF-unusable. The SF defines the notion of packet timing signal fail (PTSF), which indicates a failure of the PTP packet timing signal received by the slave.

At step 401, data set A is compared to data set B. Specifically, at step 402, GM clockClass values of A and B are compared. The field GM clockClass presents the clock class of the master. It is an attribute that defines a clock's international atomic time (TAI) traceability. The candidate values are defined in IEEE1588 2018. If GM clockClass values of A and B are equal to each other, the process proceeds to step 403 where GM clockAccuracy values of A and B are compared. The field GM clockAccuracy is used to present the accuracy of the grand master. For example, it can be 0x20, which means the clock has accuracy of 25 ns. The value of 0x20 means that the telecom grandmaster (T-GM) is connected to an enhanced primary reference timing clock (ePRTC) in locked-mode. The value of 0x21 means that the T-GM is connected to a PRTC in locked-mode. The value of 0xFE means that the T-BC-P is not connected to a global navigation satellite system (GNSS) in locked mode on a virtual PTP port. The candidate values are defined in IEEE1588 2018. If GM clockAccuracy values of A and B are equal to each other, the process proceeds to step 404 where GM offsetScaledLog Variance values of A and B are compared. The field GM offsetScaledLogVariance is used to present the dynamic accuracy behavior of the grand master. It presents the rate of change of GM accuracy which presents the static accuracy. The value of 0x4B32 means that the T-GM is connected to an ePRTC in locked-mode. The value of 0x4E5D means that the T-GM is connected to a PRTC in locked-mode. The value of 0xFFFF means that the T-GM is not connected to a PRTC in locked-mode. If GM offsetScaledLog Variance values of A and B are equal to each other, the process proceeds to step 405 where GM priority2 values of A and B are compared. The field GM Priority2 is a user configurable designation on grand master that presents the priority of the grand master clock. The value can be 0 to 255. Lower values take precedence. If GM priority2 values of A and B are equal to each other, the process proceeds to step 406 where localPriority values of A and B are compared. The LocalPriority attributes provide a powerful tool in defining the synchronization network architecture and the value is locally configurable by the operator. If localPriority values of A and B are equal to each other, the process proceeds to step 409.

In any one of steps 402-406, if the corresponding value of A is greater than the corresponding value of B, the process proceeds to step 407 where B being better than A is returned. On the other hand, in any one of steps 402-406, if the corresponding value of A is smaller than the corresponding value of B, the process proceeds to step 408 where A being better than B is returned.

At step 409, whether GM clockClass of A is 127 or less is determined. If the determination result is positive, the process proceeds to data set comparison algorithm, part 2 (FIG. 4 of G.8275.2/Y.1369.2). On the other hand, if the determination result is negative, the process proceeds to step 410 where GM clockIdentity values of A and B are compared. The field GM clockIdentity is an identifier (ID) to identify a grand master clock. If GM clockIdentity value of A is greater than that of B, the process proceeds to step 407 where B being better than A is returned. If GM clockIdentity value of A is smaller than that of B, the process proceeds to step 408 where A being better than B is returned. If GM clockIdentity values of A and B are equal to each other, the process proceeds to data set comparison algorithm, part 2 (FIG. 4 of G.8275.2/Y.1369.2).

To further illustrate the problem, the scenario of clock protection shown in FIG. 2 is taken here for detailed explanation. Assume that the key characteristics for PTP are captured as below: ClockClass #1=ClockClass #2; ClockAccuracy #1=ClockAccuracy #2; offsetScaledLogVariance #1 offsetScaledLogVariance #2; Priority2 #1=Priority2 #2; LocalPriority #1=20, Localpriority #2=10. It is obvious that the GM #2 will be selected based on the alternative BMCA algorithm captured in FIG. 4. However, in the case of the PDV shown in FIG. 3A, the GM #1 is actually the best clock. Even if in the case of the PDV shown in FIG. 3B, the GM #1 is becoming the best clock later. Therefore, the existing BMCA algorithm cannot reflect the real situation to choose the best master clock for synchronization in some cases.

The present disclosure proposes an improved solution for PTP clock synchronization. The basic idea is to provide an improved PTP clock source selection process (e.g. an optimized BMCA algorithm) by introducing a comparison of two upstream path introduced noise for better clock source selection. So it can reflect the path introduced noise, which is a critical factor to impact PTP based timing/phase synchronization especially for partial timing support scenarios.

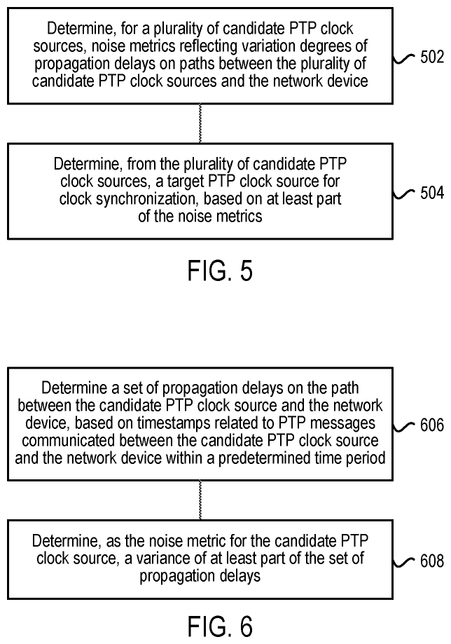

The solution may be applicable to any network device which has PTP capability and needs to carry out PTP clock source selection. Examples of the network device include, but not limited to, a router, a switch, a bridge, a gateway, and the like. The network device may also be a “multiple services network device” that provides support for multiple networking functions (e.g., routing, bridging, switching, Layer 2 aggregation, session border control, quality of service, and/or subscriber management), and/or provides support for multiple application services (e.g., data, voice, and video). When carrying out PTP clock source selection, the network device may act as any one of a BC, an ordinary clock (OC), and the like. Hereinafter, the solution will be described in detail with reference to FIGS. 5-15.

FIG. 5 is a flowchart illustrating a method performed by a network device according to an embodiment of the disclosure. At block 502, the network device determines, for a plurality of candidate PTP clock sources, noise metrics reflecting variation degrees of propagation delays on paths between the plurality of candidate PTP clock sources and the network device. The candidate PTP clock source may be mentioned relative to the path. In the path protection scenario that one master clock is connected with the network device via two or more different paths, this master clock may be deemed as two or more different candidate PTP clock sources. For a candidate PTP clock source, its noise metric reflects the variation degree of propagation delays on the path between the candidate PTP clock source and the network device. For example, the noise metric for a candidate PTP clock source may be a variance of the propagation delays on the path between the candidate PTP clock source and the network device within a predetermined time period. For this example, the determination of the noise metric for the candidate PTP clock source may be implemented as blocks 606-608 of FIG. 6.

At block 606, the network device determines a set of propagation delays on the path between the candidate PTP clock source and the network device, based on timestamps related to PTP messages communicated between the candidate PTP clock source and the network device within the predetermined time period. For example, the PTP messages may comprise a plurality of message groups communicated during the predetermined time period. Each message group may include a Sync message, a Follow Up message, a Delay Request message and a Delay Response message (note that the Follow Up message may be omitted when one-step mode is used). Accordingly, the timestamps may comprise a plurality of timestamp groups corresponding to the plurality of message groups. Each timestamp group may include a first timestamp (denoted as t1) at which the Sync message is sent from the candidate PTP clock source acting as a master, a second timestamp (denoted as t2) at which the Sync message is received by the network device, a third timestamp (denoted as t3) at which the Delay Request message is sent from the network device, and a fourth time stamp (denoted as t4) at which the Delay Request message is received by the candidate PTP clock source. Then, for each timestamp group, the corresponding propagation delay (denoted as Delay) may be determined as 0.5 multiplied by a sum of a first difference between the second and first timestamps and a second difference between the fourth and third timestamps. This may be expressed as:

$$Delay = ( t 2 - t 1 + t 4 - t 3 ) / 2 .$$

Then, the propagation delays determined from respective timestamp groups may constitute the set of propagation delays.

At block 608, the network device determines, as the noise metric for the candidate PTP clock source, a variance of at least part of the set of propagation delays. For example, the at least part of the set of propagation delays may be a predetermined number of propagation delays which are the smallest among the set of propagation delays. Alternatively, any other suitable filtering techniques may be used. Alternatively, it is also possible to determine the variance of the whole set of propagation delays. As an exemplary example, the variance may be based on Allan deviation (ADEV). Specifically, the variance (denoted as NoiseVariance) may be represented as:

$$NoiseVariance ( n τ ) = \sqrt{\frac{1}{2 {n}^{2} {τ}^{2} ( N - 2 n )} {\sum }_{i = 1}^{N - 2 n} {( {x}_{i + 2 n} - 2 {x}_{i + n} + {x}_{i} )}^{2}} ,$$

$$n = 1 , 2 … … , integer part ( \frac{N - 1}{2} ) ,$$

where n is the number of sampling intervals in one observation interval, τ is the observation interval, N is the total number of data samples, and xᵢ₊₂ₙ, xᵢ₊ₙ and xᵢ are time measurement samples (e.g. propagation delays) of respective times. Alternatively, any other existing estimation methods such as modified Allan deviation (MDEV) based method, time deviation (TDEV) based method, time interval error (TIE) based method, and maximum TIE (MTIE) based method (e.g. defined in Appendix II of ITU-T G.810), or future developed estimation methods may be used for adaptation to different network conditions.

Note that the present disclosure is not limited to the above example and there may be different ways for determining the set of propagation delays. As another example, the network device may find the minimum delay of forward (t2−t1) and the minimum delay of reverse (t4−t3) within a predetermined window (e.g. 10 seconds or 20 seconds), and then calculate the delay by using the formula [(t2−t1)+ (t4−t3)]/2. This operation may be repeated during the predetermined time period so that the set of propagation delays can be determined. Then, the variance of the set of propagation delays may be determined as the noise metric.

Also note that the noise metric is not limited to the variance, and any other suitable statistical metric may be used as the noise metric as long as it can reflect the variation degree of propagation delays on the path between the candidate PTP clock source and the network device.

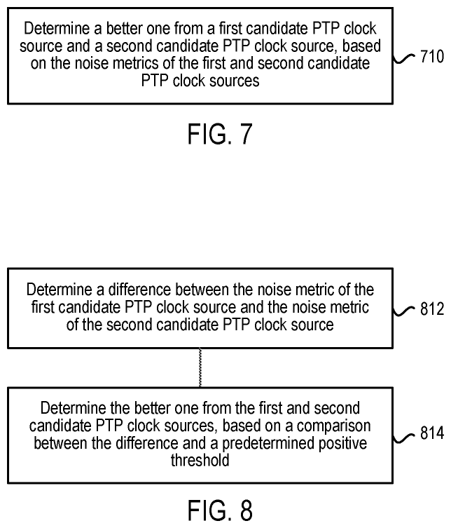

Referring back to FIG. 5, at block 504, the network device determines, from the plurality of candidate PTP clock sources, a target PTP clock source for clock synchronization, based on at least part of the noise metrics. For example, every two of the plurality of candidate PTP clock sources may be compared so that the best candidate PTP clock source may be finally determined as the target PTP clock source. As a first option, the comparison of every two candidate PTP clock sources may be implemented as block 710 of FIG. 7. At block 710, the network device determines a better one from a first candidate PTP clock source and a second candidate PTP clock source, based on the noise metrics of the first and second candidate PTP clock sources. As a simplest example, one of the first and second candidate PTP clock sources which has smaller noise metric may be determined as the better one. If the two candidate PTP clock sources have the same noise metric, another factor which will be described later may be considered to determine the better one.

As another example, block 710 may be implemented as blocks 812-814 of FIG. 8. At block 812, the network device determines a difference between the noise metric of the first candidate PTP clock source and the noise metric of the second candidate PTP clock source. At block 814, the network device determines the better one from the first and second candidate PTP clock sources, based on a comparison between the difference and a predetermined positive threshold. For instance, if the difference is smaller than an opposite number of the predetermined positive threshold (which means the first candidate PTP clock source is sufficiently better than the second PTP clock source in terms of noise metric), the first candidate PTP clock source may be determined as the better one. If the difference is greater than the predetermined positive threshold (which means the second candidate PTP clock source is sufficiently better than the first PTP clock source in terms of noise metric), the second candidate PTP clock source may be determined as the better one. If the difference is greater than or equal to the opposite number of the predetermined positive threshold and smaller than or equal to the predetermined positive threshold (which means the two candidate PTP clock sources have similar noise metrics), the first and second candidate PTP clock sources may be determined to be equally good. In this case, another factor which will be described later may be considered to determine the better one. With blocks 812 and 814, it can avoid reverting frequently between two candidate PTP clock sources with similar noise metrics.

For instance, the another factor may be capability parameters and/or the status parameters of the first and second candidate PTP clock sources. The capability parameter of a candidate PTP clock source may comprise, but not limited to, at least one of: a first parameter indicating international atomic time (TAI) traceability of the candidate PTP clock source; a second parameter indicating a static accuracy of the candidate PTP clock source; and a third parameter indicating a dynamic accuracy of the candidate PTP clock source. The candidate PTP clock source having better capability according to the capability parameters may be determined as the better one.

The status parameter of a candidate PTP clock source may comprise, but not limited to, a fourth parameter indicating whether there is a failure of PTP packet timing signal received by the network device. If one candidate PTP clock source has no failure of PTP packet timing signal and the other candidate PTP clock source has a failure of PTP packet timing signal according to the status parameters, the candidate PTP clock source having no failure of PTP packet timing signal may be determined as the better one.

In the above first option, the noise metrics of every two candidate PTP clock sources are preferentially considered and then another factor may be considered. Alternatively, as a second option, when a better one of a first candidate PTP clock source and a second candidate PTP clock source cannot be determined based on the capability parameters or the status parameters of the first and second candidate PTP clock sources, the better one may be determined based on the noise metrics of the first and second candidate PTP clock sources. For this second option, the comparison between some pair(s) of candidate PTP clock sources may be done based only on the capability parameters or the status parameters, while the comparison between some pair(s) of candidate PTP clock sources may be done based on both the capability/status parameters and the noise metrics.

Based on the above description, in both options, in the determination at block 504, the determination at block 710 may be performed at least once. Therefore, the target PTP clock source may be determined based on at least part of the noise metrics. With the method of FIG. 5, due to the consideration of the noise metrics, it is possible to select the best clock source thereby improving the clock accuracy of the network. Optionally, the target PTP clock source may be determined based further on capability parameters or status parameters of the plurality of candidate PTP clock sources.

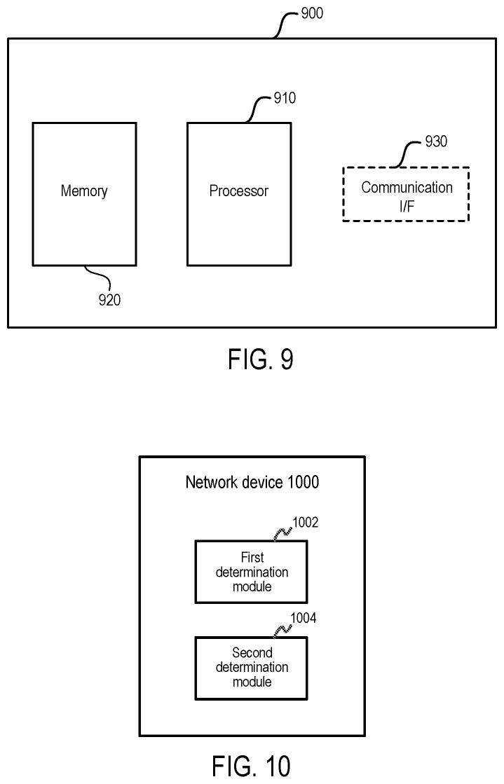

FIG. 9 is a block diagram showing an apparatus suitable for use in practicing some embodiments of the disclosure. For example, the network device described above may be implemented through the apparatus 900. As shown, the apparatus 900 may include a processor 910, a memory 920 that stores a program, and optionally a communication interface 930 for communicating data with other external devices through wired and/or wireless communication.

The program includes program instructions that, when executed by the processor 910, enable the apparatus 900 to operate in accordance with the embodiments of the present disclosure, as discussed above. That is, the embodiments of the present disclosure may be implemented at least in part by computer software executable by the processor 910, or by hardware, or by a combination of software and hardware.

The memory 920 may be of any type suitable to the local technical environment and may be implemented using any suitable data storage technology, such as semiconductor based memory devices, flash memories, magnetic memory devices and systems, optical memory devices and systems, fixed memories and removable memories. The processor 910 may be of any type suitable to the local technical environment, and may include one or more of general purpose computers, special purpose computers, microprocessors, digital signal processors (DSPs) and processors based on multi-core processor architectures, as non-limiting examples.

FIG. 10 is a block diagram showing a network device according to an embodiment of the disclosure. As shown, the network device 1000 comprises a first determination module 1002 and a second determination module 1004. The first determination module 1002 may be configured to determine, for a plurality of candidate PTP clock sources, noise metrics reflecting variation degrees of propagation delays on paths between the plurality of candidate PTP clock sources and the network device, as described above with respect to block 502. The second determination module 1004 may be configured to determine, from the plurality of candidate PTP clock sources, a target PTP clock source for clock synchronization, based on at least part of the noise metrics, as described above with respect to block 504. The modules described above may be implemented by hardware, or software, or a combination of both.

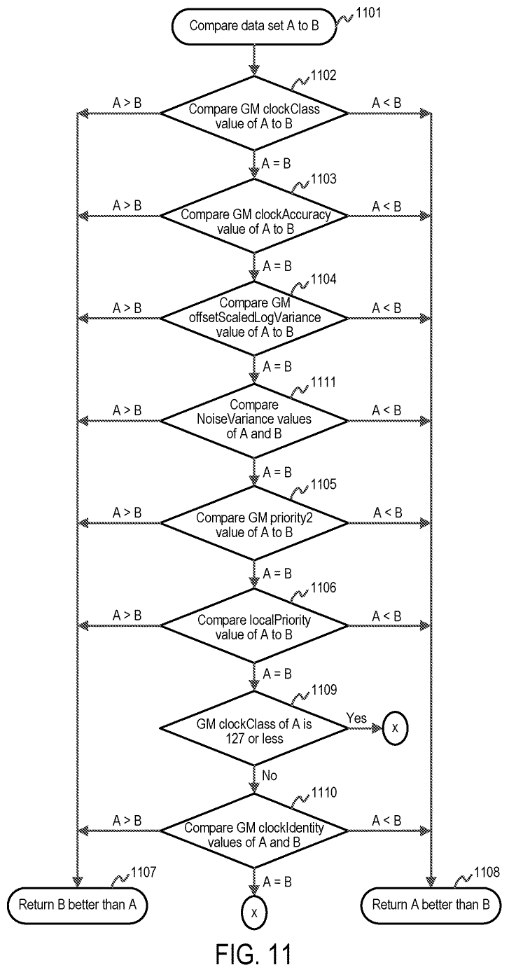

FIG. 11 is a flowchart illustrating an improved BMCA algorithm according to an embodiment of the disclosure. The noise metrics used in this embodiment is the variance (denoted as NoiseVariance) described above with respect to block 608. The algorithm selects the reference with the highest quality level that is not experiencing the SF conditions such as PTSF-lossSync or PTSF-unusable. In this improved BMCA algorithm, if the comparison of clockClass, clockAccuracy and offsetScaledLogVariance cannot declare the best master, then the comparison on the NoiseVariance is performed. Compared with the existing BMCA algorithm shown in FIG. 4, steps 1102-1110 are the same as steps 402-410 and the enhancement introduced by the embodiment is to add step 1111 between steps 1104 and 1105. Thus, only the enhancement is described below.

Specifically, If GM offsetScaledLog Variance values of A and B are equal to each other at step 1104, the process proceeds to step 1111 where NoiseVariance values of A and B are compared. If the Noise Variance value of A is greater than the Noise Variance value of B, the process proceeds to step 1107 where B being better than A is returned. On the other hand, if the Noise Variance value of A is smaller than the NoiseVariance value of B, the process proceeds to step 1108 where A being better than B is returned. If the Noise Variance values of A and B are equal to each other, the process proceeds to step 1105 where GM priority2 values of A and B are compared. Then, the process proceeds in the same way as that shown in FIG. 4.

With the improved BMCA algorithm, the path noise can be considered for best master clock selection, which can significantly improve the clock accuracy of the network to maximize the performance of telecom network.

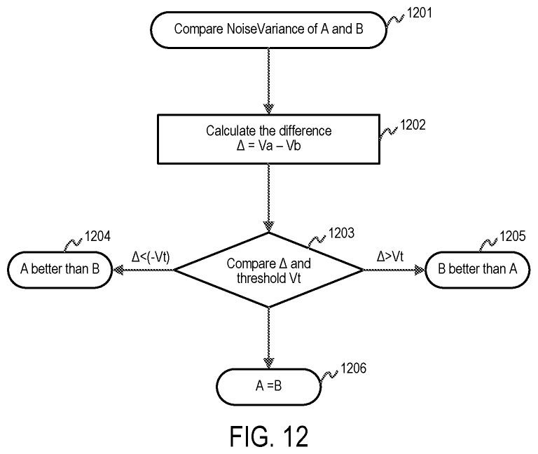

FIG. 12 illustrates an exemplary example of the comparison between the Noise Variance values in FIG. 11. This process is to compare the Noise Variance of the timestamp carried on PTP packet from grandmaster A and grandmaster B. At step 1201, the Noise Variance values of A and B are compared. Specifically, at step 1202, the difference (denoted as A) between the Noise Variance value of A (denoted as Va) and the Noise Variance value of B (denoted as Vb) are calculated. This may be expressed as: Δ=Va−Vb. At step 1203, the difference and a predetermined positive threshold (denoted as Vt) are compared. Vt is a configurable threshold which is designed for robustness consideration. For example, the operator can configure it with management system. This threshold can be useful to avoid reverting frequently between two PTP references with similar noise levels. If the difference is smaller than an opposite number of the predetermined positive threshold (i.e. Δ<−Vt, meaning that the noise carried on the PTP stream of B is sufficient larger than that carried on the PTP stream of A), then A is declared as better than B at step 1204. If the difference is greater than the predetermined positive threshold (i.e. Δ>Vt, meaning that the noise carried on the PTP stream of A is sufficient larger than that carried on the PTP stream of B), then B is declared as better than A at step 1205. If the difference is greater than or equal to the opposite number of the predetermined positive threshold and smaller than or equal to the predetermined positive threshold (i.e. −Vt≤Δ≥Vt), this means that the two PTP streams have similar level of noise. To avoid frequent reference switchover, there is no need to re-select the current master. Thus, it is determined at step 1206 that the Noise Variance values of A and B are equal to each other.

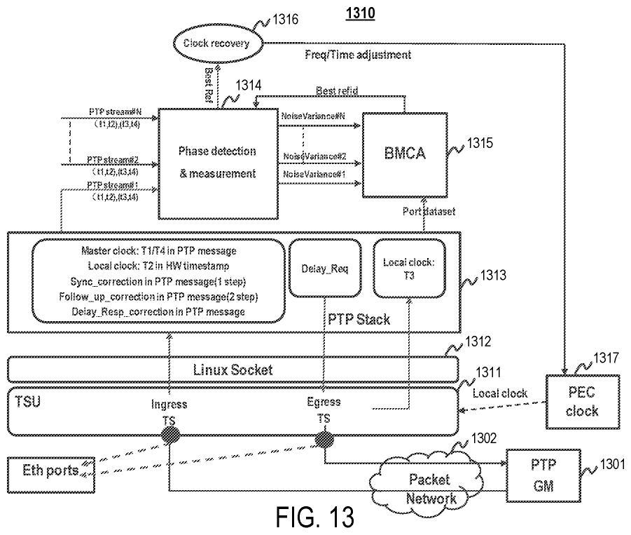

FIG. 13 is a diagram illustrating a network device according to an embodiment of the disclosure. As shown, the network device 1310 is connected with a PTP GM 1301 via a packet network 1302. In the case that there is only one PTP GM, the path protection scenario is applicable so that there are a plurality of PTP candidate clock sources. Note that the number of the PTP GMs may be two or more although only one PTP GM is shown in the figure. The network device 1310 comprises a TimeStamp Unit (TSU, e.g. Ethernet physical layer (PHY)) 1311, a Linux socket 1312, a PTP stack 1313, a phase detection and measurement component 1314, a BMCA component 1315, a clock recovery component 1316 and a packet-based equipment clock (PEC) clock 1317. PTP messages may be received on the ingress Ethernet port (simply referred to as Eth port) and timestamped in the TSU 1311. The timestamps related to the ingress Eth port comprise T1/T4 in the PTP message received from the master clock, and T2 which is hardware (HW) timestamp from the local clock. The transmitted PTP messages may also be timestamped and sent out by the egress Eth port. The timestamp related to the egress Eth port is T3 which is HW timestamp from the local clock. The components 1311, 1312, 1313, 1316 and 1317 may be similar as those of the existing network device supporting PTP.

The enhancement introduced by this embodiment lies in the components 1314 and 1315. Suppose that the total number of the received PTP streams is N. The number of the streams allowed to be monitored is implementation specific and may be limited by the system resource. The timestamp information of all these N PTP streams is provided by the PTP stack 1313 to the phase detection and measurement component 1314 so that Noise Variance values of these N PTP streams are provided to the BMCA component 1315 for comparison of any pair of candidate sources. By considering these Noise Variance values together with the port datasets corresponding to these N PTP streams, the best reference identifier (refid) identifying the best PTP stream is determined and provided to the phase detection and measurement component 1314. Then, the frequency/time adjustment information calculated from the best PTP stream may be provided by the phase detection and measurement component 1314 to the clock recovery component 1316 so that the PEC clock 1317 can be adjusted.

Thus, the phase detection and measurement component 1314 can have the following functionalities: 1) monitoring multiple PTP streams (e.g no less than 2) simultaneously for smooth reference switchover or failure detection in real time (thereby having quick fault-response) even the reference was not used for clock recovery; 2) measuring and calculating the noise variance of the PTP references dynamically so that the path quality can be evaluated based on the noise variance; 3) providing the noise variance to the PTP BMCA algorithm for best clock selection; and 4) receiving best master information from the BMCA algorithm to use the time information of the best master for clock control.

With the network device 1310, the best PTP master can be re-selected dynamically according to network noise change, so that the network node can always select and lock to the best master reference with the lowest network impairments.

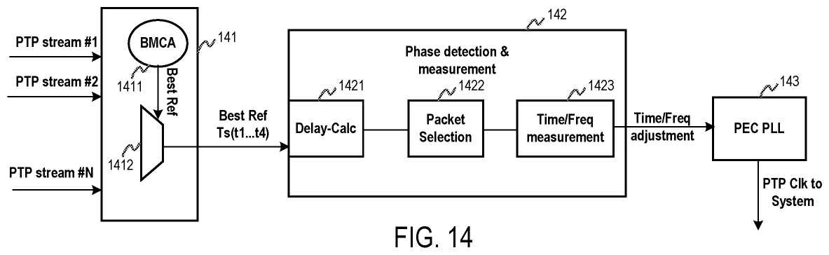

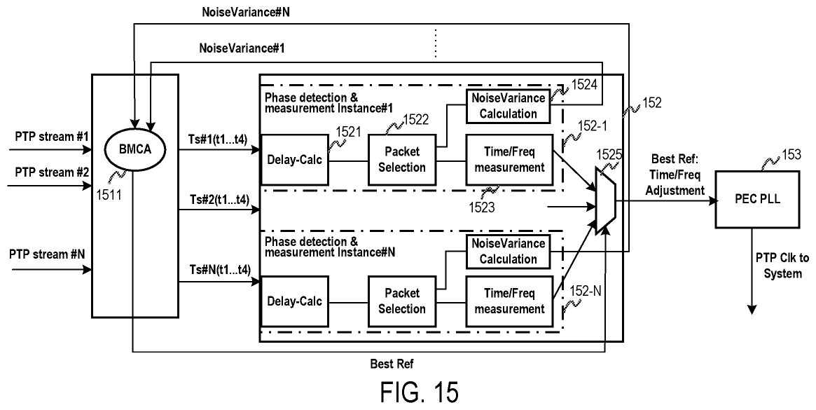

To further illustrate the enhancement introduced by the embodiment, FIG. 14 shows the typical handling of PTP in legacy, and FIG. 15 shows the PTP handling with Noise Variance calculation according to the embodiment. In the typical handling shown by FIG. 14, the PTP packets of N PTP streams may be received by the network device from the interface (e.g. Ethernet ports) and delivered to the PTP stack. The timestamps may be collected, and only the timestamps of the best master selected by the BMCA component 1411 are sent by the selector 1412 to the phase detection and measurement component 142. The phase detection and measurement component 142 can handle the timestamps by e.g. calculating propagation delays by the delay calculation component 1421, selecting packets with minimum delay principle by the packet selection component 1422, and calculating the time error/frequency error by the time/frequency measurement component 1423, so as to control the PEC phase locked loop (PLL) 143 for clock recovery.

In the PTP handling shown by FIG. 15, the timestamp information of all the received PTP stream are collected and distributed to the phase detection and measurement component 152. Multiple phase detection and measurement instances 152-1, . . . , 152-N are run to handle the multiple PTP stream's timestamps so as to perform clock recovery for warm reference evaluation. In each phase detection and measurement instance, the Noise Variance calculation component 1524 is newly added. The calculated Noise Variance of each PTP stream (also referred to as “reference”) is fed back to the BMCA component 1511 for clock selection. The BMCA component 1511 informs the phase detection and measurement component 152 of the best master clock so that the best master clock can be selected by the selector 1525 to control the PEC PLL 153 for clock recovery. Thus, with the newly added Noise Variance calculation component 1524, the BMCA component is able to reflect the on-path noise (e.g. PDV) impact on the PTP clock recovery, so that it is able to select the most suitable PTP source and improve the clock accuracy significantly.

It should be noted that the main idea of the disclosure is explained hereinabove by taking ITU-T G.8275.2 (PTP over Internet protocol (IP)) as an example, although the idea can be applicable to all the PTP profiles such as IEEE1588v2 default profile, ITU-T G.8275.1 (PTP over Eth) and G.8265.1 (PTP over IP).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a network device, comprising:
determining, for a plurality of candidate precision time protocol, PTP, clock sources, noise metrics reflecting variation degrees of propagation delays on paths between the plurality of candidate PTP clock sources and the network device; and
determining, from the plurality of candidate PTP clock sources, a target PTP clock source for clock synchronization, based on at least part of the noise metrics.

2. The method according to claim 1, wherein determining the target PTP clock source comprises:
determining a better one from a first candidate PTP clock source and a second candidate PTP clock source, based on the noise metrics of the first and second candidate PTP clock sources.

3. The method according to claim 2, wherein determining the better one from the first and second candidate PTP clock sources comprises:
determining a difference between the noise metric of the first candidate PTP clock source and the noise metric of the second candidate PTP clock source; and
determining the better one from the first and second candidate PTP clock sources, based on a comparison between the difference and a predetermined positive threshold.

4. The method according to claim 3, wherein the first candidate PTP clock source is determined as the better one, when the difference is smaller than an opposite number of the predetermined positive threshold; or
wherein the second candidate PTP clock source is determined as the better one, when the difference is greater than the predetermined positive threshold; or
wherein the first and second candidate PTP clock sources are determined to be equally good, when the difference is greater than or equal to the opposite number of the predetermined positive threshold and smaller than or equal to the predetermined positive threshold.

5. The method according to claim 1, wherein the target PTP clock source is determined based further on capability parameters or status parameters of the plurality of candidate PTP clock sources; and/or
wherein the status parameter of a candidate PTP clock source comprises:
a fourth parameter indicating whether there is a failure of PTP packet timing signal received by the network device; and/or
wherein the capability parameter of a candidate PTP clock source comprises at least one of:
a first parameter indicating international atomic time, TAI, traceability of the candidate PTP clock source;
a second parameter indicating a static accuracy of the candidate PTP clock source; and
a third parameter indicating a dynamic accuracy of the candidate PTP clock source.

6. The method according to claim 5, wherein when a better one of a first candidate PTP clock source and a second candidate PTP clock source cannot be determined based on the capability parameters or the status parameters of the first and second candidate PTP clock sources, the better one is determined based on the noise metrics of the first and second candidate PTP clock sources.

7. (canceled)

8. (canceled)

9. The method according to claim 1, wherein the noise metric for a candidate PTP clock source comprises:
a variance of the propagation delays on the path between the candidate PTP clock source and the network device within a predetermined time period; and/or
wherein the variance is based on one of:
Allan deviation, ADEV;
modified Allan deviation, MDEV;
time deviation, TDEV;
time interval error, TIE; and
maximum TIE, MTIE.

10. The method according to claim 9, wherein determining the noise metric for a candidate PTP clock source comprises:
determining a set of propagation delays on the path between the candidate PTP clock source and the network device, based on timestamps related to PTP messages communicated between the candidate PTP clock source and the network device within the predetermined time period; and
determining, as the noise metric for the candidate PTP clock source, a variance of at least part of the set of propagation delays.

11. The method according to claim 10, wherein the at least part of the set of propagation delays is a predetermined number of propagation delays which are the smallest among the set of propagation delays.

12. (canceled)

13. The method according to claim 1, wherein the network device is configured to act as one of:
a boundary clock, BC; and
an ordinary clock, OC.

14. A network device comprising:
at least one processor; and
at least one memory, the at least one memory containing instructions executable by the at least one processor, whereby the network device is operative to:
determine, for a plurality of candidate precision time protocol, PTP, clock sources, noise metrics reflecting variation degrees of propagation delays on paths between the plurality of candidate PTP clock sources and the network device; and
determine, from the plurality of candidate PTP clock sources, a target PTP clock source for clock synchronization, based on at least part of the noise metrics.

15. The network device according to claim 14, wherein the network device is operative to determine the target PTP clock source by:
determining a better one from a first candidate PTP clock source and a second candidate PTP clock source, based on the noise metrics of the first and second candidate PTP clock sources.

16. The network device according to claim 15, wherein the network device is operative to determine the better one from the first and second candidate PTP clock sources by:
determining a difference between the noise metric of the first candidate PTP clock source and the noise metric of the second candidate PTP clock source; and
determining the better one from the first and second candidate PTP clock sources, based on a comparison between the difference and a predetermined positive threshold.

17. The network device according to claim 16, wherein the first candidate PTP clock source is determined as the better one, when the difference is smaller than an opposite number of the predetermined positive threshold; or
wherein the second candidate PTP clock source is determined as the better one, when the difference is greater than the predetermined positive threshold; or
wherein the first and second candidate PTP clock sources are determined to be equally good, when the difference is greater than or equal to the opposite number of the predetermined positive threshold and smaller than or equal to the predetermined positive threshold.

18. The network device according to claim 14, wherein the network device is operative to determine the target PTP clock source based further on capability parameters or status parameters of the plurality of candidate PTP clock sources; and/or
wherein the capability parameter of a candidate PTP clock source comprises at least one of:
a first parameter indicating international atomic time, TAI, traceability of the candidate PTP clock source;
a second parameter indicating a static accuracy of the candidate PTP clock source; and
a third parameter indicating a dynamic accuracy of the candidate PTP clock source; and/or
wherein the capability parameter of a candidate PTP clock source comprises at least one of:
a first parameter indicating international atomic time, TAI, traceability of the candidate PTP clock source;
a second parameter indicating a static accuracy of the candidate PTP clock source; and
a third parameter indicating a dynamic accuracy of the candidate PTP clock source.

19. The network device according to claim 18, wherein when a better one of a first candidate PTP clock source and a second candidate PTP clock source cannot be determined based on the capability parameters or the status parameters of the first and second candidate PTP clock sources, the better one is determined based on the noise metrics of the first and second candidate PTP clock sources.

20. (canceled)

21. (canceled)

22. The network device according to claim 14, wherein the noise metric for a candidate PTP clock source comprises:
a variance of the propagation delays on the path between the candidate PTP clock source and the network device within a predetermined time period; and/or
wherein the variance is based on one of:
Allan deviation, ADEV;
modified Allan deviation, MDEV;
time deviation, TDEV;
time interval error, TIE; and
maximum TIE, MTIE.

23. The network device according to claim 22, wherein the network device is operative to determine the noise metric for a candidate PTP clock source by:
determining a set of propagation delays on the path between the candidate PTP clock source and the network device, based on timestamps related to PTP messages communicated between the candidate PTP clock source and the network device within the predetermined time period; and
determining, as the noise metric for the candidate PTP clock source, a variance of at least part of the set of propagation delays.

24. The network device according to claim 23, wherein the at least part of the set of propagation delays is a predetermined number of propagation delays which are the smallest among the set of propagation delays.

25. (canceled)

26. The network device according to claim 14, wherein the network device is configured to act as one of:
a boundary clock, BC; and
an ordinary clock, OC.

27. (canceled)
